(19) United States
(12) Patent Application Publication
(10) Pub. No.: US 2024/0002417 A1
(43) Pub. Date: Jan. 4, 2024

(54) AQUEOUS-BASED SYNTHESIS OF METAL ORGANIC FRAMEWORKS

(71) Applicant: ExxonMobil Technology and Engineering Company, Annandale, NJ (US)

(72) Inventors: Anna C. IVASHKO, Denville, NJ (US); Carter W. ABNEY, Athens, WI (US); Nicole M. HERB, Allentown, PA (US); Preeti KAMAKOTI, Berkeley Heights, NJ (US); Aaron W. PETERS, New Hope, PA (US); Matthew T. KAPELEWSKI, Flemington, NJ (US); Marc H. ANTHONIS, Hofstade (BE); Roxana PEREZ VELEZ, Leuven (BE); Nadya A. HRYCENKO, Clinton, NJ (US); Doron LEVIN, Highland Park, NJ (US); Tara L. REDDINGTON, Easton, PA (US); Scott J. WEIGEL, Allentown, PA (US)

(21) Appl. No.: 17/856,041

(22) Filed: Jul. 1, 2022

(51) Int. Cl. C07F 13/00; C07F 3/02; C01B 39/00

(52) U.S. Cl. CPC C07F 13/005; C07F 3/02; C01B 39/00

(57) ABSTRACT

Methods are provided for synthesizing metal organic framework compositions in an aqueous environment and/or in a mixed alcohol/water solvent. The methods can allow for formation of MOF-274 metal organic framework compositions, such as EMM-67 (a mixed metal MOF-274 metal organic framework composition). More generally, the methods can allow for formation of MOF structures that include disalicylate linkers in an aqueous environment and/or in a mixed alcohol/water solvent.

### FIELD

Methods are provided for synthesizing metal organic framework materials in aqueous or partially aqueous solvent environments.

### BACKGROUND

Traditional synthesis methods for making metal organic frameworks involve complete dissolution of solids in organic solvents forming a reaction solution that then enhances metal organic framework growth at elevated temperatures. Often the prerequisite of such synthesis is a large volume of solvent required for reagent dissolution. For crystal growth, however, the amount of the solid reagents needed to make the metal organic framework is often the limiting factor.

Traditional synthetic protocols can have several major drawbacks, including long reaction time and low yield. While yields obtained using traditional solvothermal methods are reasonable for laboratory use, the methods are inefficient on an industrial scale in terms of time, separation of solvents, and heating. Optimization and scale-up of metal organic framework syntheses are particularly challenging due to the nature of the materials as they often require large amounts of solvents and can accommodate small amounts of solids. This naturally results in poor yields of materials and extremely intensive processes in order to produce enough material for testing. Additionally, the organic solvents required for such traditional synthesis protocols are also less desirable, as such solvents can require increased or specialized care to handle safely.

A need exists, therefore, for synthesis of metal organic frameworks that produce higher yields of metal organic frameworks with reduced labor than that typically required to obtain high quality metal organic frameworks. Preferably, the improved synthesis methods can reduce or minimize the need to use organic solvents during the synthesis process.

U.S. Pat. No. 9,861,953, describes a metal organic framework, MOF-274. This framework can be synthesized from individual metal precursors, but not a mixed-metal organic framework. Other types of metal organic frameworks are described in J. Am. Chem. Soc, 2012, 134, 7056-7065, Nature, 2015, 519, 303-308, J. Am. Chem. Soc, 2017, 139, 10526-10538, J. Am. Chem. Soc. 2017, 139, 13541-13553, and Chem Sci, 2018, 9, 160.

In an article titled “Synthesis of Metal Organic Frameworks in Water at Room Temperature: Salts as Linker Sources”, a water based synthesis is described for making MOF-74, a metal organic framework structure based on a linker that includes a single aromatic ring.

International Publication No. WO/2020/219907 describes mixed-metal mixed-organic framework systems for selective CO₂ capture.

U.S. Patent Application Publication 2021/0053903 describes methods for selecting solvents for synthesis of metal organic framework compositions based on Hansen solubility parameters.

U.S. Pat. No. 7,411,081 describes a process for preparing an organometallic framework material. The process includes reacting at least one metal salt with a ligand in an aqueous solvent system in the presence of at least one base.

### SUMMARY

In various aspects, a method of making a metal organic framework composition is provided. The method includes dissolving a plurality of solid reagents in a solvent corresponding to 40 vol % or more of water, to provide a synthesis solution. The plurality of solid reagents can include at least one metal salt and at least one multi-ring disalicylate linker. The at least one metal salt can correspond to an oxide, a hydroxide, a carbonate, an acetate, or a combination thereof. The synthesis solution can consist essentially of the solvent, the at least one metal salt, and the at least one multi-ring disalicylate linker. Additionally, the method includes heating the synthesis solution to form a composition corresponding to a metal organic framework, wherein the metal organic framework comprises the metal of the at least one metal salt and the multi-ring disalicylate organic linker.

In some aspects, the at least one metal salt can correspond to a metal oxide, metal hydroxide, metal carbonate, or metal acetate. In some aspects, the synthesis solution can further include at least one of a base and a buffer. In some aspects, the solvent can include an organic base. In some aspects, the solvent can include one or more alcohols. In some aspects, the solvent can include 90 vol % or more of water, or 99 vol % or more of water.

### BRIEF DESCRIPTION OF THE DRAWINGS

FIG. 1 shows the powder x-ray diffraction data of MOF-274 via synthesis in an aqueous environment.

FIG. 2 shows SEM images of MOF-274 prepared using a traditional synthesis mixture.

FIG. 3 shows SEM images of MOF-274 prepared using synthesis in an aqueous environment.

### DETAILED DESCRIPTION

In various aspects, methods are provided for synthesizing metal organic framework compositions in an aqueous environment and/or in a mixed alcohol/water solvent. The methods can allow for formation of MOF-274 metal organic framework compositions, such as EMM-67 (a mixed metal MOF-274 metal organic framework composition). More generally, the methods can allow for formation of MOF structures that include multi-ring disalicylate organic linkers in an aqueous environment and/or in a mixed water/organic solvent environment. Using an aqueous environment or a mixture of 40 vol % or more water (or 50 vol % or more water) plus organic solvent can provide a variety of advantages. The advantages can include, but are not limited to, increased density of synthesis reagents in the solvent, and reducing or minimizing the use of organic solvents that require special safety handling.

In addition to allowing for increased density of synthesis reagents, it has been discovered that an aqueous environment and/or mixed water/organic solvent environment can allow for formation of MOF structures from synthesis mixtures that do not include a base or buffer. Instead of using a base or buffer, the synthesis mixture can include the aqueous solvent and/or mixture of water and organic solvent; at least one multi-ring disalicylate linker; and one or more metal reagents selected from metal oxides, metal hydroxides, metal carbonates, metal acetates and/or metal sources that allow for MOF formation without the need for buffer/base addition. Additionally, in some aspects, the synthesis mixture can have an unexpectedly high density of reagents, allowing for more efficient synthesis of MOF structures.

The metal organic framework compositions formed using an aqueous solvent or a mixed solvent of water and organic solvent can have substantially the same structural features and properties and/or improved features and properties relative to corresponding compositions synthesized using a conventional organic solvent environment, such as metal organic framework compositions synthesized in a solvent environment corresponding to a mixture of methanol and N,N-dimethylformamide. After formation of the metal organic framework composition, further reactions can be performed on the metal organic framework composition. For example, EMM-67 (an example of a MOF-274 metal organic framework composition) can be further reacted to append suitable amines to the composition in order to form EMM-44.

In some aspects, the solvent environment for performing synthesis of the metal organic framework composition can correspond to water, such as deoxygenated water. In such aspects, bases such as sodium hydroxide can be added to the aqueous environment to control the pH of the aqueous environment. Additionally or alternately, metal reagents can be used that correspond to metal oxides, metal hydroxides, metal carbonates, and/or metal acetates or other metal reagents in order to control the pH of the aqueous environment. In such aspects, the synthesis solution can include solvent, linker(s), and metal reagent(s) without the presence of an additional base or buffer.

In this discussion, a synthesis solution that consists essentially of solvent, linker(s), and metal reagent(s) is defined as a synthesis solution that does not include a separately added base or buffer. Other components can be added to the synthesis solution, so long as such other components do not have a substantial impact on the pH of the synthesis solution. In this discussion, a substantial impact on the pH of the synthesis solution can be determined by comparison of the pH of the synthesis solution with the pH of a mixture containing only the solvent, linker(s), and metal reagent(s) in the same molar ratio as the synthesis solution. A substantial impact in pH is defined as the pH of the synthesis solution being different from the pH of a mixture containing only the solvent, linker(s), and metal reagent(s) in the same molar ratio by 0.5 or less, or 0.2 or less, such as down to having substantially no difference in pH between the synthesis solution and the mixture. If the pH of the synthesis solution is different from the pH of such a mixture by 0.5 or less, or 0.2 or less, then the synthesis solution is defined as having substantially the same pH as the mixture containing only the solvent, linker(s), and metal reagent(s) in the same molar ratio. As an example, if the pH of the synthesis solution is 8.0, then any additional components in the synthesis solution would not have a substantial impact on the pH (i.e., the pH would be substantially the same) if a mixture containing only solvent, linker(s), and metal reagent(s) in the same ratio has a pH between 7.5 and 8.5, or 7.8 and 8.2.

In other aspects, the solvent environment can correspond to a mixture of water and organic solvent. Alcohols are examples of organic solvents that can be used, such as C₄₋ alcohols that have reduced or minimized requirements for safety handling relative to conventional organic solvents. Examples of suitable alcohols include ethanol and isopropyl alcohol, although methanol and the isomers of propanol and n-butanol can also be suitable. Other examples of organic solvents can include other oxygenated solvents such as tetrahydrofuran. In aspects where the solvent corresponds to a mixture of water and one or more other organic solvents, water can correspond to 40 vol % to 99 vol % (or 50 vol % to 99 vol %) of the solvent. In this discussion, a solvent including 99.0 vol % or more of water is defined as a solvent that consists essentially of water. In such aspects, one or more buffers can be added to the solvent environment to control the pH of the solvent environment. Additionally or alternately, metal reagents can be used that correspond to metal oxides, metal hydroxides, metal carbonates, and/or metal acetates in order to control the pH of the solvent environment. In such aspects, the synthesis mixture can include solvent, linker, and metal reagents without the presence of an additional base or buffer.

By way of nonlimiting example, metal organic frameworks can be synthesized by dissolving one or more metal salts with one or more linkers in a solvent at a target molar ratio to produce a synthesis solution. This target molar ratio can be specified, for example, based on the moles of linkers to combined moles of metals in the metal salts. In various aspects, the ratio of linkers to metals in the metal salts in the synthesis solution can be 0.20 to 0.60, or 0.25 to 0.60, or 0.30 to 0.60, or 0.20 to 0.55, or 0.25 to 0.55, or 0.30 to 0.55, or 0.20 to 0.50, or 0.25 to 0.50. It is noted that the metals in the metal salts refers to metals from the metal salts for incorporation into the metal organic framework composition. Metals added as part of a base or buffer (such as Na from NaOH) are not included, as metals such as Na are not incorporated in a stoichiometric manner into the metal organic framework composition. However, metals such as MgO, Mg(OH)₂, or Mn(OH)₂ are included, as such metals correspond to reagents containing metals that are stoichiometrically incorporated into the metal organic framework composition.

It was unexpected that synthesis of MOF-274 metal organic framework compositions and/or metal organic framework compositions including multi-ring disalicylate organic linkers could be achieved in an aqueous solvent environment and/or an environment where water corresponds to 40 vol % or more of the solvent environment. Conventionally, synthesis of MOF-274 is performed in organic solvents, such as mixtures of methanol and N,N-dimethylformamide. Based on Hansen solubility parameters, some variation in solvent systems can be used, and water can potentially be included as a portion of a solvent when attempting to build similar solvent systems. However, one of the three types of Hansen solubility parameters is δ_{H}, which is related to the hydrogen bonding characteristics of a potential solvent. The δ_{H} value for water is extremely high relative to even alcohols such as methanol. Thus, when attempting to identify potential alternative solvent systems based on Hansen solubility parameters, it would be expected that water would need to be paired with organic solvents with low δ_{H} values. This would exclude combinations of water with any substantial amount of alcohols. Additionally, the amount of water would need to be limited to roughly 30 vol % or less even when paired with organic solvents having low δ_{H} values, so that the combined solvent system would have a comparable δ_{H} to a conventional organic solvent system. It is further noted that because of the multi-ring nature of the linker, it would not be expected that a synthesis procedure for a metal organic framework based on a single-ring linker would be relevant to identifying synthesis conditions for MOF-274. For example, single-ring linkers would be expected to have higher solubility in aqueous environments than multi-ring linkers. Additionally, multi-ring linkers are generally used for formation of larger pore materials than single ring linkers. Such larger pore sizes increase the difficulty with production of the materials, because larger pore sizes can accommodate other defect phases and/or can be susceptible to pore collapse.

The metal organic framework compositions formed using water or high water content solvents as the solvent environment can have various characteristics. In some aspects, the metal organic framework compositions can have a surface area, as determined by nitrogen adsorption (ASTM D3663, BET surface area) of 700 m²/g or more, or 900 m²/g or more, or 1500 m²/g or more, such as up to 4000 m²/g or possibly still higher. Additionally or alternately, the metal organic framework compositions can have a pore volume, as determined by nitrogen adsorption (ASTM D4641) of 0.6 cm³/g to 1.6 cm³/g.

### Definitions

All numerical values within the detailed description and the claims herein are modified by “about” or “approximately” the indicated value, and take into account experimental error and variations that would be expected by a person having ordinary skill in the art.

It is to be understood that unless otherwise indicated this invention is not limited to specific compounds, components, compositions, reactants, reaction conditions, ligands, catalyst structures, metallocene structures, or the like, as such may vary, unless otherwise specified. It is also to be understood that the terminology used herein is for the purpose of describing particular embodiments only and is not intended to be limiting.

For the purposes of this disclosure, the following definitions will apply:

As used herein, the terms “a” and “the” as used herein are understood to encompass the plural as well as the singular.

As used herein, the term “heteroatom” includes oxygen (O), nitrogen (N), sulfur (S) and silicon (Si), boron (B) and phosphorous (P).

The term “multi-ring” is defined herein to refer to compounds that include two or more ring structures. The rings can correspond to fused rings, such as a naphthalene-type structure, rings bonded together without sharing an atom, such as a biphenyl linkage, or rings separated by one or more atoms, such as rings separated by a methyl linkage. This is in contrast to a single-ring compound. A multi-ring compound can include multiple aromatic rings, multiple non-aromatic rings (such as saturated rings and/or rings including an insufficient number of double bonds to provide aromaticity), or a combination thereof.

The term “aryl” means, unless otherwise stated, a polyunsaturated, aromatic substituent that can be a single ring or multiple rings fused together or linked covalently. In an aspect, the substituent has from 1 to 11 rings, or more specifically, 1 to 3 rings. The term “heteroaryl” refers to aryl substituent groups (or rings) that contain from one to four heteroatoms selected from N, O and S, wherein the nitrogen and sulfur atoms are optionally oxidized, and the nitrogen atom(s) are optionally quaternized. An exemplary heteroaryl group is a six-membered azine, e.g., pyridinyl, diazinyl and triazinyl. A heteroaryl group can be attached to the remainder of the molecule through a heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below.

As used herein, the terms “alkyl,” “aryl,” and “heteroaryl” can optionally include both substituted and unsubstituted forms of the indicated species. Substituents for the aryl and heteroaryl groups are generically referred to as “aryl group substituents.” The substituents are selected from, for example: groups attached to the heteroaryl or heteroarene nucleus through carbon or a heteroatom (e.g., P, N, O, S, Si, or B) including, without limitation, substituted or unsubstituted alkyl, substituted or unsubstituted aryl, substituted or unsubstituted heteroaryl, substituted or unsubstituted heterocycloalkyl, —OR′, ═O, ═NR′, ═N—OR′, —NR′R″, —SR′, -halogen, —SiR′R″R′″, —OC(O)R′, —C(O)R′, —CO.sub.2R′, —CONR′R″, —OC(O)NR′R″, —NR″C(O)R′, —NR′—C(O)NR″R′″, —NR″C(O).sub.2R′, —NR—C(NR′R″R′″).dbd.NR″″, —NR—C(NR′R″)═NR′″, —S(O)R′, —S(O)R′, —S(O)NR′R″, —NRSOR′, —CN and, —R′, —, —CH(Ph), fluoro(C₁-C₄)alkoxy, and fluoro(C₁-C₄)alkyl, in a number ranging from zero to the total number of open valences on the aromatic ring system. Each of the above-named groups is attached to the aryl or heteroaryl nucleus directly or through a heteroatom (e.g., P, N, O, S, Si, or B); and where R′, R″, R′″ and R″″ are preferably independently selected from hydrogen, substituted or unsubstituted alkyl, substituted or unsubstituted heteroalkyl, substituted or unsubstituted aryl and substituted or unsubstituted heteroaryl. When a compound of the invention includes more than one R group, for example, each of the R groups is independently selected as are each R′, R″, R′″ and R″″ groups when more than one of these groups is present.

The term “alkyl,” by itself or as part of another substituent, means, unless otherwise stated, a straight or branched chain, or cyclic hydrocarbon radical, or combination thereof, which may be fully saturated, mono- or polyunsaturated and can include di-, tri- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to optionally include those derivatives of alkyl defined in more detail below, such as “heteroalkyl.”

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH·₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —CO₂R′— represents both —C(O)OR′ and —OC(O)R′.

As used herein, the term “ligand” means a molecule containing one or more substituent groups capable of functioning as a Lewis base (electron donor). In an aspect, the ligand can be oxygen, phosphorus or sulfur. In an aspect, the ligand can be an amine or amines containing 1 to amine groups.

The terms “halo” or “halogen,” by themselves or as part of another substituent, mean, unless otherwise stated, a fluorine, chlorine, bromine, or iodine atom.

The symbol “R” is a general abbreviation that represents a substituent group that is selected from H, substituted or unsubstituted alkyl, substituted or unsubstituted heteroalkyl, substituted or unsubstituted aryl, substituted or unsubstituted heteroaryl, and substituted or unsubstituted heterocycloalkyl groups.

As used herein, the term “Periodic Table” means the Periodic Table of the Elements of the International Union of Pure and Applied Chemistry (IUPAC), dated December 2015.

The term “salt(s)” includes salts of the compounds prepared by the neutralization of acids or bases, depending on the particular ligands or substituents found on the compounds described herein. When compounds of the present invention contain relatively acidic functionalities, base addition salts can be obtained by contacting the neutral form of such compounds with a sufficient amount of the desired base, either neat or in a suitable inert solvent. Examples of base addition salts include sodium, potassium, calcium, ammonium, organic amino, or magnesium salt, or a similar salt. Examples of acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids, and the like, as well as the salts derived from relatively nontoxic organic acids like acetic, propionic, isobutyric, butyric, maleic, malic, malonic, benzoic, succinic, suberic, fumaric, lactic, mandelic, phthalic, benzenesulfonic, p-tolylsulfonic, citric, tartaric, methanesulfonic, and the like. Certain specific compounds of the present disclosure contain both basic and acidic functionalities that allow the compounds to be converted into either base or acid addition salts. Hydrates of the salts are also included.

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure or be stereoisomeric mixtures. In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the subject compounds, whether radioactive or not, are intended to be encompassed within the scope of present disclosure.

In some optional aspects, deoxygenated water can be used. Deoxygenated water corresponds to water with an oxygen content of 0.1 wppm or less, or 0.01 wppm or less. The water can be deoxygenated by any convenient method, such as sparging the water by passing nitrogen gas through the water in substantially oxygen-free atmosphere (such as under a nitrogen blanket). More generally, sparging and/or other deoxygenation techniques can be used to deoxygenate mixtures of water and an organic solvent.

### Traditional Synthesis

Traditionally, metal organic frameworks are prepared by reactions of pre-synthesized or commercially available linkers with metal ions. An alternative approach, referred to as “in situ linker synthesis,” specified organic linkers (linkers) can be generated in the reaction media in situ from the starting materials.

In synthesizing the metal organic framework, organic molecules are used not only structure-directing agents but as reactants to be incorporated as part of the framework structure. With this in mind, elevated reaction temperatures are generally employed in conventional synthesis. Solvothermal reaction conditions, structure-directing agents, mineralizers as well as microwave-assisted synthesis or steam-assisted conversions have also been recently introduced.

As referred to herein, the traditional synthesis is typically reactions carried out by conventional electric heating without any parallel reactions. In the traditional synthesis, reaction temperature is a primary parameter of a synthesis of the metal organic framework and two temperature ranges, solvothermal and nonsolvothermal, are normally distinguished, which dictate the kind of reaction setups to be used. Solvothermal reactions generally take place in closed vessels under autogenous pressure about the boiling point of the solvent used. Nonsolvothermal reactions take place below, or at the boiling point under ambient pressure, simplifying synthetic requirements. Nonsolvothermal reactions can be further classified as room-temperature or elevated temperatures.

Traditional synthesis of metal organic frameworks takes place in an organic solvent environment and at temperatures ranging from room temperature to approximately 250° C. Heat is transferred from a hot source, the oven, through convection. Alternatively, energy can be introduced through an electric potential, electromagnetic radiation, mechanical waves (ultrasound), or mechanically. The energy source is closely related to the duration, pressure, and energy per molecule that is introduced into a system, and each of these parameters can have a strong influence on the metal organic framework formed and its morphology.

Traditional synthesis of metal organic frameworks is described in McDonald, T., Mason, J., Kong, X. et al, Cooperative insertion of CO₂ in diamine-appended metal organic frameworks, Nature 519, 303-08 (2015), which is incorporated herein by reference. Generally, 0.10 mmol of a linker, 0.25 mmol of metal salts, and 10 mL of a solvent, i.e., methanol/dimethylformamide (DMF) are combined together in a 20 mL glass scintillation vial. The vial is then sealed and placed in a well plate two (2) cm deep on a 393° K hot plate for about 12 hours, after which a powder forms on the bottom and walls of the vial. The metal organic framework material is then decanted and the remaining powder soaked three times in DMF and then three times in methanol. The metal organic frameworks are then collected by filtration and fully desolvated by heating under dynamic vacuum (<10 μbar) at 523° K for 24 hours. Using this specific methodology, the traditional synthesis method yields about 0.073 mmol of metal organic frameworks, or 73% yield (comparing mmol of the metal organic frameworks produced to initial mmol of linker) or a volume-normalized mass-based yield of 2.7 grams MOF per liter of reaction solution.

In addition to the traditional synthesis described in Nature, 2015, 519, 303-308, incorporated herein by reference, synthesis of making metal organic frameworks are further described in: J. Am. Chem. Soc. 2012, 134, 7056-7065; Chem. Sci, 2018, 9, 160-174; U.S. Pat. No. 8,653,292 and US Patent Appl. Pub. Nos. 2007/0202038, 2010/0307336, and 2016/0031920.

### Synthesis of Metal Organic Frameworks in Water or Water/Alcohol Solvent Environments

In various aspects, methods are provided for synthesis of metal organic framework compositions in an aqueous or water/alcohol solvent environment. By using a solvent environment that is at least partially based on water, it has been discovered that the reagent concentration in the synthesis solution can be increased to include up to 30 times as much of the reagents as a conventional solvothermal synthesis in organic solvents. As used herein, the term “solid reagents” refers to a combination of one or more metal salts and one or more organic linkers (“linkers”). Generally, the organic linker can correspond to a multi-ring linker. In some aspects, the organic linker includes multiple bridged aryl species such as molecules having two or more phenyl rings or two phenyl rings joined by a biphenyl, vinyl, or alkynyl group. For example, an organic linker can correspond to a disalicylate. In some aspects, a plurality of rings in the multi-ring disalicylate organic linker can include a salicylate functional group.

The increase in reagent concentration in the solution is facilitated in part by the higher solubility of the various types of solid reagents in an at least partially aqueous environment. In aspects where the solvent environment also includes an alcohol, a buffer can optionally be added to the solvent to maintain the pH in a desired range in order to further facilitate dissolution of the high concentrations of solid reagents. In aspects where water is substantially the only solvent (i.e., 99 vol % or more of the solvent is water), a base can be optionally added to adjust the pH of the water.

The synthesis can include methods of making metal organic frameworks where one or more metal salt(s), one or more linkers, and optionally a buffer mixture and/or a base are combined and dissolved in an at least partially aqueous solvent to provide a synthesis solution. It is noted that if one or more metal salts corresponds to a metal oxide, metal hydroxide, metal carbonate, and/or a metal acetate, a buffer or base may not be needed. Similarly, if a portion of the solvent corresponds to a base, a separate buffer or base may not be needed. Optionally, dissolution of the reagents can include stirring of the solution until full dissolution is achieved. The synthesis solution is then sealed and heated by one of various methods.

In an aspect, the cumulative concentration of one or more metal salts can be provided in an amount between 100 mM and 4850 mM (or equivalently 0.1 M to 4.85 M). In an aspect, one or more linkers can be provided in an amount between 30 mM and 1950 mM (or equivalently 0.03 M to 1.95 M). In aspects where a buffer is added, the buffer concentration can be between 100 mM and 7800 mM (or equivalently 0.1 M to 7.8 M). In aspects where a base is added, the base concentration can be between 100 mM and 5000 mM (or equivalently 0.1 M to 5.0 M). In such aspects, the synthesis solution can have a combined concentration of metal salts and linkers of 130 mM to 6800 mM (or equivalently 0.13 M to 6.8 M). In such aspects, the synthesis solution can have a total reagent concentration (metal salts, linkers, optional buffer and/or base) of 230 mM to 14500 mM (or equivalently 0.23 M to 14.5 M).

In various aspects, the metal salts can be divalent metal salts. For example, the metal salts can be a divalent first-row transition metal salt having the formula MX2 such as M=Mg, Mn; X₂═(Oac)₂, (HCO₃)₂, (F₃CCO₂)₂, (acac)₂, (F₆acac)₂, (NO₃)₂, SO₄; M=Ni, X₂═(Oac)₂, (NO₃)₂, SO₄; M=Zn, X₂═(Oac)₂, (NO₃)₂. In an aspect, the metal salts can be in the form of crystals or crystalline powder. In an aspect, the metal salts are Mg(NO₃)₂·6H₂O and MnCl₂·4H₂O for example. In some aspects, one or more metal salts can correspond to a metal oxide, metal hydroxide, metal carbonate, and/or metal acetate. In an aspect, the resulting metal organic framework is Mg/Mn-MOF-274, sometimes referred to as MOF-274.

As described herein, some suitable linkers can be formed by two phenyl rings joined at carbon 1,1′ (i.e., a biphenyl type linkage), with carboxylic acids on carbons 3, 3′, and alcohols on carbons 4,4′. This linker can be referred to as “H₄DOBPDC”. In such aspects, switching the position of the carboxylic acids and the alcohols (e.g., “pc-H₄DOBPDC” or “pc-MOF-274”) still allows for formation of a metal organic framework. In an aspect, the linker is H₄DOBDPC.

In some aspects, the solvent environment can be substantially composed of and/or consist essentially of water (i.e., solvent environment is 99 vol % or more of water). In other aspects, the solvent can include 40 vol % to 99 vol % of water mixed with one or more alcohols. Examples of suitable alcohols include ethanol and isopropyl alcohol, although other C₄₋ alcohols (e.g., methanol and the isomers of propanol and n-butanol) can also be suitable. In still other aspects, the solvent can include 40 vol % to 99 vol % of water mixed with one or more other organic solvents. Tetrahydrofuran is an example of another potential solvent. More generally, organic solvents that are fully miscible with water can also be used. It is noted that some organic bases, such as pyridine or dimethyl formamide, may be able to serve as a solvent and/or a base.

Metal organic frameworks can be synthesized at room temperature, or using conventional electric heating, microwave heating, electrochemistry, mechanochemistry, and/or ultrasonic methods. Conventional step-by-step methods as well as high-throughput methods can be employed as well. In any synthesis, however, conditions must be established to produce defined inorganic building blocks without decomposition of an organic linker. At the same time, kinetics of crystallization must allow for nucleation and growth of the desired phase to take place.

The heating and sealing steps can include heating the reaction solution in static conditions for about 96 hours. The heating and sealing steps can include heating the reaction solution under dynamic (e.g. stirred, shaken, mixed, agitated) conditions for about 24 hours. The heating and sealing steps can include heating the reaction solution in a static oven at about 120° C. The heating and sealing steps can include heating the reaction solution in a rotating oven at about 150° C. The heating can be done without sealing, with the MOF synthesized with the solvent(s) at reflux under approximately 1 bar of pressure. In an aspect, the reaction solution is generally heated to 50° C. to 175° C. (or 100° C. to 160° C., or 115° C. to 145° C.) for 1 hour to 7 days, or 6 hours to 5 days, or 12 hours to 3 days. The reaction solution can be centrifuged or filtered to obtain the metal organic frameworks and washed.

In an aspect, the buffer comprises a Brønsted acid and its conjugate base, or a Brønsted base and its conjugate acid. In an aspect, the reaction solution or the reaction mixture is heated between about 25° C., and about 160° C.

In an aspect, the reaction solution is subject to autogenous pressurization. In an aspect, the linker comprises multiple bridged aryl species having two or more phenyl rings or two phenyl rings joined by a vinyl group or an alkynyl group. In an aspect, the linker is H₄DOBDPC. In an aspect, the metal salts are prepared by neutralization of acids or bases of a metal ion. In an aspect, the metal salts are Mg(NO₃)₂·6H₂O and MnCl₂·4H₂O. In an aspect, the buffer is Na MOPS. In an aspect, the metal organic frameworks comprise metal ions of one more distinct elements and a plurality of organic linkers, wherein each organic linker is connected to one of the metal ions of two or more distinct elements. In an aspects, the organic linker(s) correspond to disalicylate linker(s). In an aspect, the metal organic framework is MOF-274. In an aspect, nominal pH of the reaction solution allows for linker deprotonation. In an aspect, the solvent is selected by evaluation of Hansen solubility parameters. In an aspect, the reaction solution is heated in static conditions. In an aspect, the reaction solution is heated at about 120° C. In an aspect, the metal organic framework has an N₂ absorption between about 25 mmol/g and about 40 mmol/g at relative pressure between about 0.1 and about 0.9. In an aspect, the metal organic framework produces powder x-ray diffraction peaks at 2θ values between about 4° and about 6° and between about 7° and about 9°. In an aspect, the metal organic frameworks produce powder x-ray diffraction peaks at 2θ values which are about equal to metal organic frameworks made by a traditional synthesis.

In an aspect, the metal organic frameworks provide an X-ray diffraction pattern having a unit cell that can be indexed to a hexagonal unit cell. In an aspect, the unit cell is selected from space groups 168 to 194 as defined in the International Tables for Crystallography. In an aspect, the present metal organic frameworks further comprise a metal rod structure composed of face-sharing octahedral, described by the Lidin-Andersson helix, as identified by Schoedel, Li, Li, O'Keeffe, and Yaghi, Chem Rev. 2016 116, 12466-12535. In an aspect, the metal organic framework has a hexagonal pore oriented parallel to the metal rod structure. In an aspect, the present metal organic frameworks display a (3,5,7)-c msi net, according to the approach described by Schoedel, Li, Li, O'Keeffe, and Yaghi, Chem Rev. 2016 116, 12466-12535. In an aspect, The metal organic framework displays a (3,5,7)-c msg net, according to the approach described by Schoedel, Li, Li, O'Keeffe, and Yaghi, Chem Rev. 2016 116, 12466-12535.

In an aspect, the subject metal organic frameworks express peak maxima in the X-ray diffraction pattern at 30° C. after drying at 250° C. under N₂ for 30 minutes at:

d(Å)
18.65 ± 0.5
10.79 ± 0.5
9.35 ± 0.5
7.07 ± 0.5
6.51 ± 0.5
6.24 ± 0.5
5.84 ± 0.5
5.41 ± 0.5
5.19 ± 0.5

In an aspect, the express peak maxima in the X-ray diffraction pattern at 30° C. after drying at 250° C. under N₂ for 30 minutes at:

d(Å)
18.65 ± 0.5
10.79 ± 0.5
7.07 ± 0.5
5.41 ± 0.5
5.19 ± 0.5

In an aspect, an A axis of the unit cell and a B axis of the unit cell are each greater than 18 Å, and a c axis is greater than 6 Å.

In various aspects, synthesizing MOFs in an aqueous environment and/or a solvent environment including 40 vol % or more of water can be advantageous, as such synthesis methods can reduce the cost and labor required in order to obtain high quality MOFs. Since the methods require less time and more material can be synthesized, the resulting methods can also provide more material available for testing and characterization and reduce the amount of time significantly, which can have a significant economic impact. Thus, aqueous synthesis and/or synthesis in a solvent environment including 40 vol % or more of water can represent a process intensification of MOF synthesis.

### Metal Organic Framework

In various aspects, methods are provided for forming metal organic framework compositions from an aqueous synthesis mixture or a synthesis mixture including a substantial portion of water. The metal organic framework can include a single metallic element, or the metal organic framework can correspond to a mixed-metal organic framework that includes a plurality of distinct metallic elements. The metallic element(s) in the metal organic framework can be bridged by a plurality of organic linkers, where each linker is connected to at least one metal ion.

In an example where a single metallic element (such as a single divalent metal ion) is used, the metal organic framework can be represented by the formula M¹₂A, wherein M¹ is a metal and A is an organic linker as described herein, such as one or more disalicylate linkers.

In another aspect, a mixed-metal organic framework can have the general Formula I:

M¹ₓM²₍₂₋ₓ₎(A) I

wherein M¹ is a metal and M² is a metal, but M¹ is not M²;

X is a value from 0 to 2, or 0.01 to 1.99; and

A is an organic linker as described herein, such as one or more disalicylate linkers.

In general, X can have any value between 0 and 2. It is note that both X=0 and X=2 result in a metal organic framework that includes only a single metal. In an aspect, X is a value from 0.01 to 1.99. In an aspect, X is a value from 0.1 to 1. In an aspect, X is a value selected from the group consisting of 0.05, 0.1, 0.5 and 1. Further, while X and 2-X represent the relative ratio of M¹ to M², it should be understood that any particular stoichiometry is not implied in Formula I, Formula IA, Formula II or Formula III described herein. As such, the mixed-metal organic frameworks of the Formula I, IA, II or III are not limited to a particular relative ratio of M¹ to M². It is further understood that the metals are typically provided in ionic form and available valency will vary depending on the metal selected.

The metal of a metal organic framework as described herein (including a metal organic framework according to Formula I, IA, II, or III) can be one of the elements of Period 4 Groups IIA, IIIB, IVB, VB, VIB, VIIB, VIII, IB and IIB of the Periodic Table and Period 3 Group IIA including Mg, Ca, V, Mn, Cr, Fe, Co, Ni, Cu and Zn. Furthermore, in aspects where a plurality of metals are present, the mixed-metal organic framework can include two or more distinct elements as well as different combination of metals, theoretically represented as M¹ₓM²_{y} . . . Mⁿ_{z}(A)(B)₂|x+y+ . . . +z=2 and M¹≠M²≠ . . . ≠Mⁿ.

In some aspects where only a single metal is present, the metal can be selected from Mg, V, Ca, Mn, Cr, Fe, Co, Ni, Cu and Zn. In some aspects where a plurality of metals are present, such as according to Formula I, M¹ can selected from Mg, V, Ca, Mn, Cr, Fe, Co, Ni, Cu and Zn; and M² can be selected from Mg, V, Ca, Mn, Cr, Fe, Co, Ni, Cu and Zn, provided that M¹ is not M². In another aspect, M¹ is selected from the group consisting of Mg, Mn, Ni and Zn; and M² is selected from the group consisting of Mg, Mn, Ni and Zn; provided M¹ is not M². In yet another aspect, M¹ is Mg and M² is Mn. In still another aspect, M¹ is Mg and M² is Ni. In yet another aspect, M¹ is Zn and M² is Ni. It is further understood that the metals are typically provided in an ionic form and the valency will vary depending on the metal selected. Further, the metals can be provided as a salt or in salt form.

Additionally or alternately, in aspects where the metal organic framework corresponds to a mixed-metal organic framework, at least one metal can be a monovalent metal that would make A the protonated form of the linker H-A. For example, the metal can be Na⁺ or one from Group I. Also, the metal can be one of two or more divalent cations (“divalent metals”) or trivalent cations (“trivalent metals”). In an aspect, the mixed metal mixed organic framework includes metals which are at oxidation states other than +2 can (i.e., more than just divalent, trivalent tetravalent, . . . ). The framework can have metals comprising a mixture of different oxidation states. Exemplary mixtures include Fe(II) and Fe(III), Cu(II) and Cu(I) and/or Mn(II) and Mn(III). More specifically, trivalent metals are metals having a +3 oxidation state. Some metals used to form the mixed-metal organic framework, specifically Fe and Mn, can adopt +2 (divalent) or +3 (trivalent) oxidation states under relatively gentle conditions. Chem. Mater, 2017, 29, 6181. Likewise, Cu(II) can form Cu(I) under gentle conditions. As such, any minor change to the oxidation state of any of the metals and/or selective change in the oxidation state of a metal can be used to modify the present mixed-metal organic frameworks. Furthermore, any combination of different molecular fragments C₁, C₂, . . . Cₙ may exist. Finally, all of the above variations can be combined, for example, multiple metals (two or more distinct metals) with multiple valences and multiple charge-balancing molecular fragments.

Suitable organic linkers (also referred to herein as “linkers”) can be determined from the structure of the mixed-metal organic framework and the symmetry operations that relate the portions of the organic linker that bind to the metal node of the mixed-metal organic framework. A ligand which is chemically or structurally different, yet allows the metal node-binding regions to be related by a C₂ axis of symmetry, will form a mixed-metal organic framework of an identical topology. In an aspect, the organic linker can be formed by two phenyl rings joined at carbon 1,1′, with carboxylic acids on carbons 3, 3′, and alcohols on carbons 4,4′. Switching the position of the carboxylic acids and the alcohols (e.g., “pc-H₄DOBPDC” described below) still allows for formation of a mixed-metal organic framework.

Generally, the linker can correspond to a disalicylate. A disalicylate corresponds to a linker that includes two monohydroxybenzoate groups.

In an aspect, useful linkers include:

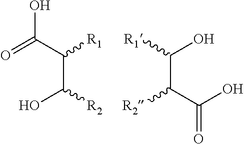

where R₁ is connected to R₁′ and R₂ is connected to R₂.″

Examples of such linkers include:

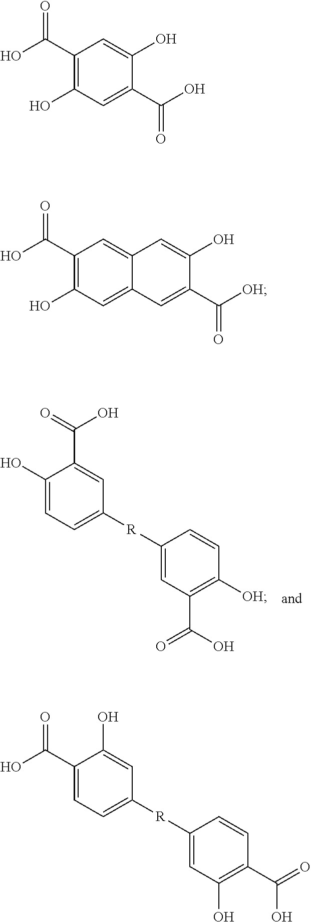

where R is any molecular fragment.

Examples of suitable organic linkers include para-carboxylate (“pc-linker”) such as 4,4′-dioxidobiphenyl-3,3′-dicarboxylate (DOBPDC); 4,4″-dioxido-[1,1′:4′,1″-terphenyl]-3,3″-dicarboxylate (DOTPDC); and dioxidobiphenyl-4,4′-dicarboxylate (para-carboxylate-DOBPDC also referred to as PC-DOBPDC) as well as the following compounds:

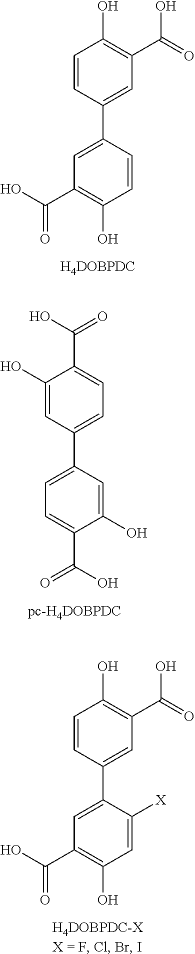

In an aspect, the organic linker has the formula:

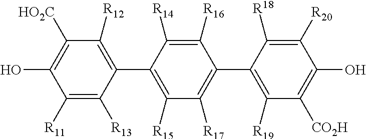

where R₁₁, R₁₂, R₁₃, R₁₄, R₁₅, R₁₆, R₁₇, R₁₈, R₁₉, and R₂₀ are each independently selected from H, halogen, hydroxyl, methyl, and halogen substituted methyl.

In an aspect, the organic linker has the formula:

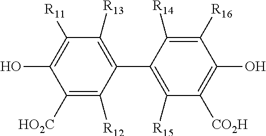

where, R₁₁, R₁₂, R₁₃, R₁₄, R₁₅, and R₁₆ are each independently selected from H, halogen, hydroxyl, methyl, and halogen substituted methyl.

In an aspect, the organic linker has the formula:

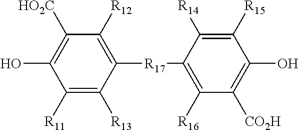

where R₁₁, R₁₂, R₁₃, R₁₄, R₁₅, and R₁₆ are each independently selected from H, halogen, hydroxyl, methyl, or halogen substituted methyl, and R₁₇ is selected from substituted or unsubstituted aryl, vinyl, alkynyl, and substituted or unsubstituted heteroaryl.

In an aspect, the organic linker has the formula:

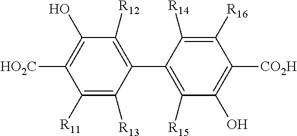

where R₁₁, R₁₂, R₁₃, R₁₄, R₁₅, and R₁₆ are each independently selected from H, halogen, hydroxyl, methyl, or halogen substituted methyl.

where R₁₁, R₁₂, R₁₃, R₁₄, R₁₅, and R₁₆ are each independently selected from H, halogen, hydroxyl, methyl, or halogen substituted methyl, and R₁₇ is selected from substituted or unsubstituted aryl, vinyl, alkynyl, and substituted or unsubstituted heteroaryl.

In an aspect, the organic linker includes multiple bridged aryl species such as molecules having two (or more) phenyl rings or two phenyl rings joined by a vinyl or alkynyl group.

In an aspect, a mixed-metal organic framework can correspond to structural Formula IA:

M¹ₓM²₍₂₋ₓ₎(A) IA

wherein M¹ is a metal independently selected from Mg, Ca, V, Mn, Cr, Fe, Co, Ni, Cu or Zn, or salt thereof;

M² is a metal independently selected from Mg, Ca, V, Mn, Cr, Fe, Co, Ni, Cu or Zn or salt thereof, but M¹ is not M²;

X is a value from 0.01 to 1.99; and

A is an organic linker as described herein.

As described herein, the mixed-metal mixed-organic frameworks are porous crystalline materials formed of two or more distinct metal cations, clusters, or chains joined by two or more multitopic (polytopic) organic linkers.

Chemical Buffers and/or Base Addition

In some aspects, solubility of the reagent is maximized by inclusion of a chemical buffer (referred to herein as a “buffer”), fixing nominal pH of the reaction solution to allow linker deprotonation and subsequent formation of the metal organic framework. The buffer can include an acid and its conjugate base, or a base and its conjugate acid. The buffers can be generated in situ by addition of the buffering acid followed by addition of a basic solution to the appropriate pH. Similarly, the buffers can be generated in situ by addition of the buffering base followed by addition of an acidic solution to the appropriate pH. In an aspect, the buffer can be 3-(N-morpholino)propanesulfonic acid (“MOPS”) or Na MOPS.

In other aspects, a base can be added to the water and/or water plus organic solvent environment, as opposed to adding an acid/base combination to form a buffer. In still other aspects, some solvents may be able to serve as both a base and a solvent. In such aspects, addition of a separate base or buffer is optional. Examples of such solvents can include, but are not limited to, pyridine and dimethyl formamide. In yet other aspects, if a metal oxide, metal hydroxide, metal carbonate, and/or metal acetate is used as a source of metal for forming the metal organic framework, addition of a separate base or buffer is optional.

Examples of suitable bases include, but are not limited to, piperazine, 1,4-dimethylpiperazine, pyridine, 2,6-lutidine, sodium hydroxide, potassium hydroxide, lithium hydroxide, various types of amines (primary, secondary, and/or tertiary), ammonium hydroxide and the like, and any combination thereof.

Examples of suitable acids include, but are not limited to, hydrochloric acid, nitric acid, citric acid, oxalic acid, malonic acid, succinic acid, glutaric acid, acetic acid, perchloric acid, phosphoric acid, phosphorus acid, sulfuric acid, formic acid, hydrofluoric acid, and the like, and any combination thereof.

Examples of suitable acids and conjugate bases, and suitable bases and conjugate acids which are used to buffer the nominal pH include, but are not limited to, acetic acid/acetate, citric acid/citrate, boric acid/borate, and the like, the buffers known as “Good Buffers” defined in Biochemistry, 1966, 5, 467-477, incorporated herein by reference, and the noncomplexing tertiary amine buffers known as “Better Buffers” defined in Anal Chem., 1999, 71, 3140-3144, incorporated herein by reference.

Buffers can include potential variations on MOPS and can be of the formula:

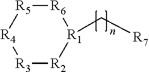

wherein n=is an integer between 1 and 10, and any atoms bridging R₁ and R₇ can be functionalized with chemical substituents, or “R” as defined in paragraphs [0027 through [0030], [0032], and [0033] above;
R₁, R₂, R₃, R₄, R₅, and R₆ are each independently C, O, N or S; and

R₇ is any Brønsted acid functional group or corresponding conjugate base, sulfonic acid, phosphonic acid and/or sulfoxylate, phosphonate, phosphate, hydroxyl, ammonia, or sulfate.

### Variations on MOF Structures

MOF-274 is an example of a type of MOF that can be synthesized using disalicylate linkers. The traditional MOF-274 structure corresponds to M₂(dobpdc) where M=various 2+ metal ions. Many variations of MOF-274 can be formed that also correspond to metal organic framework materials. Examples of these variations are described here for MOF-274, but it is understood that this is to illustrate the nature of the variations. Thus, similar variations on other types of metal organic framework materials that also include disalicylate linkers are also contemplated herein.

In some aspects, one type of variation corresponds to MₓN₂₋ₓ(dobpdc), where M and N are different 2+ metal ions. This represents a variation where two different types of divalent metal ions are included in the metal organic framework material. Another variation can be to have more than two different types of divalent metal ions. Still another variation can be to have a plurality of metal ions, with some metal ions having an oxidation state different from 2+. Yet another variation corresponds to M_{x-y}N_{2-x-z}(dobpdc)_{1-y} where M and N are the same or different 2+ metal ions, z and y are <2, and the structure contains defects in the form of missing metals.

In some aspects, a type of variation corresponds to MₓN₂₋ₓ(dobpdc)_{1-y} where M and N are the same or different 2+ metal ions and the structure contains defects in the form of missing linkers. Another type of variation corresponds to MₓN₂₋ₓ(dobpdc)_{1-y}A where M and N are the same or different 2+ metal ions and the structure contains defects in the form of missing linkers and A is a charge balancing anion (e.g. Cl⁻, F⁻, Br⁻, OH⁻, NO₃⁻). Yet another type of variation corresponds to M_{x-y}N_{2-x-y}(dobpdc)Z, where M and N are the same or different 2+ metal ions and the structure contains defects in the form of missing linkers and Z is a charge balancing cation (e.g. H⁺, Na⁺, K⁺).

In some aspects, a type of variation corresponds to MₓN₂₋ₓ(dobpdc)Sol_{0.1-2} where M and N are the same or different 2+ metal ions and the structure contains defects in the form of missing linkers and Sol is a coordinating monodentate ligand (such as OH₂, MeOH, DMF, MeCN, THF, NR₃, HNR₂, H₂NR). Another type of variation corresponds to MₓN₂₋ₓ(dobpdc)Sol_{0.15-1} where M and N are the same or different 2+ metal ions and the structure contains defects in the form of missing linkers and Sol is a coordinating bidentate ligand.

Washing of MOF Compositions after Synthesis

After forming an MOF using an aqueous-based synthesis mixture, the MOF is typically washed prior to use. It has been discovered that MOFs such as EMM-67 (and/or other MOFs based on multi-ring disalicylate linkers) can be washed using a wash procedure that reduces or minimizes the number of wash steps and/or the volume of solvents required during the wash. Additionally, such MOFs can be washed using only water and alcohols as the solvents for the wash.

In various aspects, the wash steps can be performed via trituration, where the solid MOF material is stirred in the wash solvent. The MOF can be separated from the solvent after a wash step by filtration. The wash can be performed at any convenient temperature, such as a temperature between 0° C. and 70° C. Temperatures near ambient can be a convenient choice.

One option for evaluating the effectiveness of a washing method can be evaluated based on the sharpness of peaks in an X-Ray Diffraction spectrum. Another option can be based on surface area, such as BET surface area. For example, for EMM-67, a target threshold for sufficient washing can be to achieve a BET surface area of 2000 m²/g or more, or 2600 m²/g or more. It is noted that a MOF sample may be able to achieve a still higher surface area if additional washing is performed. The threshold values for sufficient washing are used to indicate when sufficient washing has been performed so that the MOF is ready for use, and do not necessarily indicate that further washing would result in no further increases in surface area or XRD peak sharpness.

In some aspects, a wash procedure for a MOF based on a multi-ring disalicylate linker can be to perform either one or two water wash steps, followed by two alcohol wash steps. An ethanol wash step is an example of an alcohol wash step. During a wash step, the amount of solvent used during a wash step can be characterized based on milliliters of solvent per gram of MOF. The amount of solvent can also vary depending on the nature of the solvent In various aspects, the amount of solvent used during an alcohol wash step can correspond to 6.0 mL solvent/g MOF to 30 mL solvent/g MOF, or 6.0 mL solvent/g MOF to 20 mL solvent/g MOF, or 6.0 mL solvent/g MOF to 15 mL solvent/g MOF, or 8.0 mL solvent/g MOF to 30 mL solvent/g MOF, or 8.0 mL solvent/g MOF to 20 mL solvent/g MOF. In various aspects, the amount of solvent used during a water wash step can correspond to 4 mL solvent/g MOF to 150 mL solvent/g MOF, or 10 mL solvent/g MOF to 100 mL solvent/g MOF, or 10 mL solvent/g MOF to 50 mL solvent/g MOF, or 10 mL solvent/g MOF to 30 mL solvent/g MOF.

### Carbon Dioxide Applications

In some aspects, a mixed-metal organic framework that contains more than one metal species of ions (a “cluster”) can be later functionalized (or appended) with a diamine ligand (a “ligand”) to provide a mixed-metal mixed-organic framework system. Such a mixed-metal mixed-organic framework system can be useful as adsorbent or adsorbent material of CO₂ in various applications and emission streams. The mixed-metal organic framework can be prepared from multiple metal sources and is appended by one or more organic ligand such as an amine to provide the mixed-metal mixed-organic framework system. In various aspects, the mixed-metal mixed-organic framework system can display a Type-V isotherm.

For example, in an aspect, an EMM-67 mixed-metal organic framework can be later functionalized with the amine 2-(aminomethyl)-piperidine (2-ampd) to provide the mixed-metal mixed-organic framework system EMM-44. This mixed-metal mixed-organic framework system can reversibly and selectively bind to CO₂ and can be regenerated for repeat use by mild heating or by exposing to vacuum. The required percentage of CO₂ to be adsorbed in a gas stream and the required temperature for binding can be adjusted by varying the ratio of the two metal ions in the mixed-metal organic framework, allowing for broad distribution and implementation in CO₂ capture from diverse emission streams.

More generally, a ligand appended to a metal organic framework structure can correspond to a ligand containing one or more groups capable of functioning as suitable Lewis base (electron donor) such as oxygen, phosphorus or sulfur or an amine having 1 to 10 amine groups. Ligands suitable for use in the mixed-metal mixed-organic framework systems can have (at least) two functional groups: 1) A functional group used to bind CO₂ and 2) a functional group used to bind the metal. The second functional group that binds the metal can also be an amine. It is possible to use other functional groups such as oxygen containing groups like alcohols, ethers or alkoxides, carbon groups like carbenes or unsaturated bonds like alkenes or alkynes, or sulfur atoms.

One benefit of adsorbents based on an MOF-274/EMM-67/EMM-44 type structure is that additional control over adsorption profiles can be achieved in various ways. For example, by varying the ratio of metals incorporated in the mixed-metal organic framework, a position of the step in the isotherm can be varied as a function of CO₂ partial pressure. This feature can be used to develop additional types of adsorbent systems. As an example, in an aspect, a series of several mixed-metal organic frameworks, each comprising both Mg and Mn ions, can be functionalized with amine 2-ampd to provide a series of mixed-metal mixed-organic framework systems. When exposed to CO₂, the material with the least amount of Mn and greatest amount of Mg displays a Type-V isotherm at the lowest pressure of CO₂. The material with the most Mn and least amount of Mg displays a Type-V isotherm at the highest pressure of CO₂. A direct relationship is observed between the ratio of Mn to Mg contained in the mixed-metal mixed organic framework system and the pressure of CO₂ where the Type-V isotherm is observed.

Methods of use for adsorption materials based on EMM-44 include a variety of gas separation and manipulation applications including the isolation of individual gases from a stream of combined gases, such as carbon dioxide/nitrogen, carbon dioxide/hydrogen, carbon dioxide/methane, carbon dioxide/oxygen, carbon monoxide/nitrogen, carbon monoxide/methane, carbon monoxide/hydrogen, hydrogen sulfide/methane and hydrogen sulfide/nitrogen.

Among the primary benefits of physisorption onto solid materials is the low regeneration energy compared to that required for aqueous amines. However, this benefit frequently comes at the expense of low capacity and poor selectivity. The present systems provide adsorbents (adsorbent materials) that can bridge the two approaches through the incorporation of sites that bind CO₂ by chemisorption onto solid materials. These adsorption materials may eliminate the need for aqueous solvents, and may have significantly lower regeneration costs compared with traditional amine scrubbers, yet maintain their exceptional selectivity and high capacity for CO₂ at low pressures.

In an aspect, the EMM-44 mixed-metal mixed-organic framework system can separate gases at low temperatures and pressures. For example, EMM-44 can be useful for pre-combustion separation of carbon dioxide and hydrogen and methane from a stream of gases and for separation of carbon dioxide from a stream of post-combustion flue gases at low pressures and concentrations. More generally, EMM-44 can be adapted to many different separation needs.

As further examples, there are a number of technical applications for materials capable of adsorption of CO₂. One such application is carbon capture from coal flue gas or natural gas flue gas. The increasing atmospheric levels of carbon dioxide (CO₂), which are contributing to global climate change, warrant new strategies for reducing CO₂ emissions from point sources such as power plants. In particular, coal-fueled power plants are responsible for 30-40% of global CO₂ emissions. See, Quadrelli et al., 2007, “The energy-climate challenge: Recent trends in CO₂ emissions from fuel combustion,” Energy Policy 35, pp. 5938-5952, which is hereby incorporated by reference. Thus, there remains a continuing need for the development of new adsorbents for carbon capture from coal flue gas, a gas stream consisting of CO₂ (15-16%), 02 (3-4%), H₂O (5-7%), N₂ (70-75%), and trace impurities (e.g. S02, NOx) at ambient pressure and 40° C. See, Planas et al., 2013, “The Mechanism of Carbon Dioxide Adsorption in an Alkylamine-Functionalized Metal organic Framework,” J. Am. Chem. Soc. 135, pp. 7402-7405, which is hereby incorporated by reference. Similarly, growing use of natural gas as a fuel source necessitates the need for adsorbents capable of CO₂ capture from the flue gas of natural gas-fired power plants. Flue gas produced from the combustion of natural gas contains lower CO₂ concentrations of approximately 4-10% CO₂, with the remainder of the stream consisting of H₂O (saturated), O₂ (4-12%), and N₂ (balance). In particular, for a temperature swing adsorption process an adsorbent should possess the following properties: (a) a high working capacity with a minimal temperature swing, in order to minimize regeneration energy costs; (b) high selectivity for CO₂ over the other constituents of coal flue gas; (c) 90% capture of CO₂ under flue gas conditions; (d) effective performance under humid conditions; and (d) long-term stability to adsorption/desorption cycling under humid conditions.

Another potential application for EMM-44 is carbon capture from crude biogas. Biogas, the CO₂/CH₄ mixtures produced by the breakdown of organic matter, is a renewable fuel source with the potential to replace traditional fossil fuel sources. Removal of CO₂ from the crude biogas mixtures is one of the most challenging aspects of upgrading this promising fuel source to pipeline quality methane. Therefore, the use of adsorbents to selectively remove CO₂ from CO₂/CH₄ mixtures with a high working capacity and minimal regeneration energy has the potential to greatly reduce the cost of using biogas in place of natural gas for applications in the energy sector.

The EMM-44 adsorption materials described herein can be used to strip a major portion of the CO₂ from the CO₂-rich gas stream, and the adsorption material enriched for CO₂ can be stripped of CO₂ using a temperature swing adsorption method, a pressure swing adsorption method, a vacuum swing adsorption method, a concentration swing adsorption method, or a combination thereof. Example temperature swing adsorption methods and vacuum swing adsorption methods are disclosed in International Publication Number WO2013/059527 A1.

Isosteric heat of adsorption calculations provide an indicator of the strength of the interaction between an adsorbate and adsorbent, specifically determined from analysis of adsorption isotherms performed across a series of different temperatures. J. Phys. Chem. B, 1999, 103, 6539-6545; Langmuir, 2013, 29, 10416-10422. Differential scanning calorimetry is a technique which measures the amount of energy released or absorbed as a parameter (such as temperature or CO₂ pressure) varies.

### Comparative Example 1—Traditional Synthesis Methods for MOF-274

An example of a synthesis method can be taken from J. Am. Chem. Soc, 2017, 139, 10526-10538. In short, 9.89 g (36.1 mmol) linker H₄DOBPDC is combined with 11.5 g (44.9 mmol) of Mg(NO₃)₂·6H₂O and dissolved in 200 mL of 55:45 (v/v) methanol:N,N-dimethylformamide (DMF) solution via sonication. Reaction mixture is then placed in 350 mL glass pressure vessel, sealed, and heated to 120 C for 20 hrs, and the solids were collected and washed with DMF and methanol after the heat treatment. This Example of MOF-274 can be referred to herein as Reference Material A.

### Example 2—Preparation of EMM-67 Via Aqueous Synthesis

In order to prepare EMM-67, 4 mmol of H₄DOBPDC were dispersed in 15 mL of water and combined in a Teflon™ liner. Then, 7.62 mmol of MgO and 0.38 mmol of MnO were added to the ligand and water. The resulting synthesis gel was well mixed. The synthesis gel in the Teflon™ liner was sealed on a high throughput synthesis tool and heated to 120° C. for 16 hrs. The resulting product mixture was then cooled to room temperature, followed by washing the product mixture several times with water and then ethanol. The product was collected from the product mixture via centrifugation.

### Example 3—Characterization of Structure for MOF-274 and EMM-67 Samples

The materials prepared in Example 2 were characterized using powder X-ray diffraction (PXRD) and scanning electron microscopy (SEM) to verify that the crystal structure, crystallinity, and morphology of the materials prepared in Examples 2-5 were comparable to MOF-274 prepared by conventional methods. For comparison, a sample of MOF-274 prepared according the method used for making Reference A from Example 1 was also characterized. It is noted that for the sample prepared according to the method for Reference A, the sample was prepared using a scaled down recipe to allow the sample to be made in a 45 mL vessel.

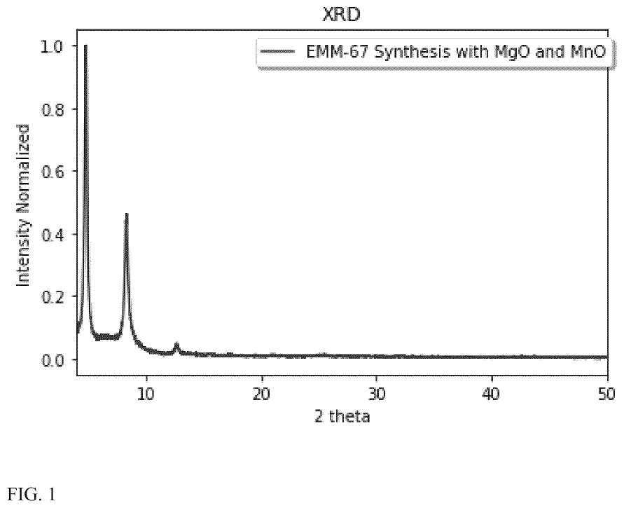

FIG. 1 shows the powder X-ray diffraction patterns for the materials from Example 2. As shown in FIG. 1, the powder x-ray diffraction patterns confirm that the material prepared using the aqueous based synthesis method was substantially the same as an EMM-67 material prepared using a conventional non-aqueous solvent. Specifically, the metal organic frameworks prepared by the high concentration synthesis and high solids synthesis exhibited powder x-ray diffraction peaks at 2θ values between about 4° and about 6° and between about 7° and about 9°, these 20 values being similar to those of the metal organic frameworks produced by the traditional synthesis. It is noted that prior to the XRD analysis, an amine was not appended to these metal organic frameworks nor was the metal organic framework functionalized or activated.

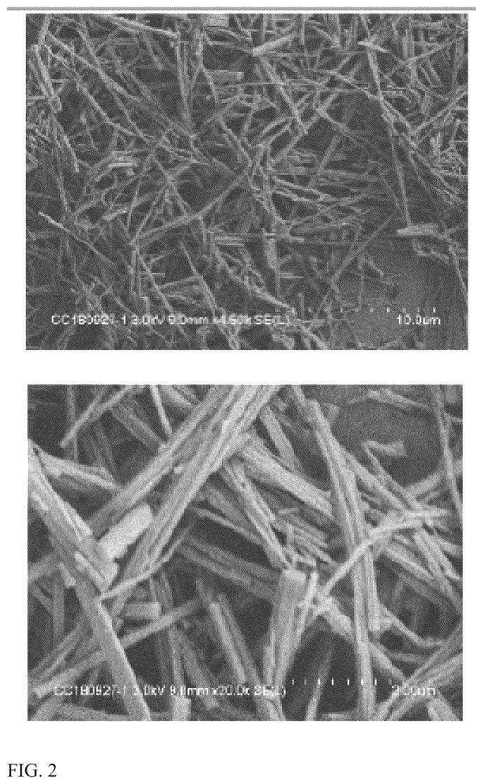

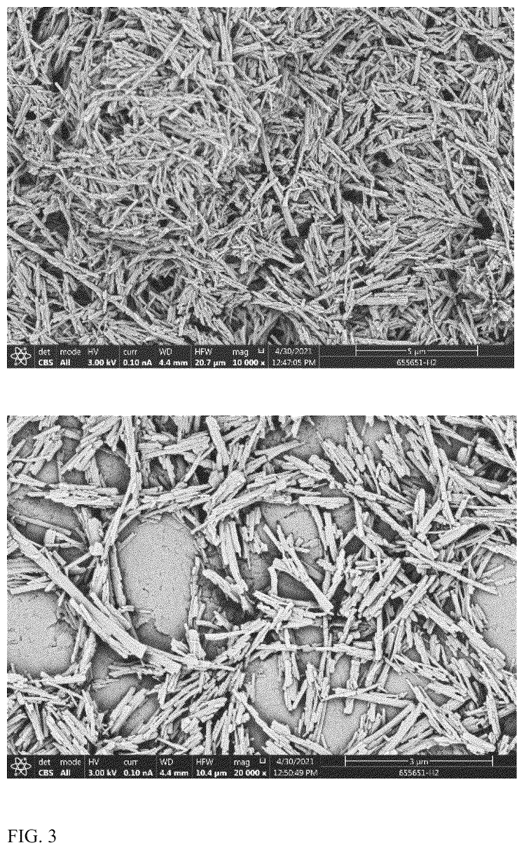

The powder x-ray diffraction patterns in FIG. 1 further revealed comparable material crystallinity. This is also supported by a comparison of the SEM images shown in FIG. 2 and FIG. 3. The SEM images in FIG. 2 correspond to SEM images at different magnifications of the Reference A MOF-274 material that was made using a mixture of Mg and Mn (thus corresponding to EMM-67) with a conventional synthesis procedure in organic solvents. FIG. 3 corresponds to SEM images of the mixed metal MOF materials made in Example 2 using a solvent corresponding to a mixture of water and ethanol.

The SEM images in FIG. 2 and FIG. 3 display a persistent rod-shaped morphology accompanied by discrete crystallite formation, regardless of the type of solvent environment used for the synthesis. FIG. 2 and FIG. 3 also show the bulk material shape, morphology, and a qualitative appraisal of material polydispersity. The SEM images were collected on a Hitachi SEM at 2 keV acceleration using the upper detector.

### Examples 4-7: Synthesis Methods Using Metal Hydroxides and/or Metal Oxides

Examples 4-7 correspond to additional examples where use of a metal hydroxide and/or metal oxide as the source of metal avoids the need to introduce a separate base or buffer into the reaction mixture.

### Example 4—Synthesis of EMM-67 in Water with Mg(OH)₂ and MnCl₂

In order to prepare EMM-67, H₄DOBPDC ligand was added to a vessel with distilled water. The ligand slurry was stirred for five minutes. Then, Mg(OH)₂ and MnCl₂·4H₂O were added to the ligand solution and stirred for an additional 5 min. The resulting molarity for the various components in the solution was ˜0.26 M H₄DOBPDC, ˜0.55 M Mg(OH)₂, and ˜0.027 M MnCl₂. The metal and ligand solution was transferred to a Teflon-lined autoclave, sealed, and placed in a 120° C. oven for 16 h under static conditions.

### Example 5—Synthesis of Mg-MOF-274 in Water with MgO

In order to prepare MOF-274, H₄DOBPDC ligand was added to a vessel with distilled water. The ligand slurry was stirred for five minutes. Then, MgO was added to the ligand solution and stirred for an additional 5 min. The resulting molarity for the various components in the solution was ˜0.51 M H₄DOBPDC, and ˜1.16 M MgO. The metal and ligand solution was transferred to a Teflon-lined autoclave, sealed, and placed in a 120° C. oven for 16 h under static conditions.

### Example 6—Synthesis of EMM-67 in Water with MgO and MnCl₂

In order to prepare EMM-67, H₄DOBPDC ligand was added to a vessel with distilled water. The ligand slurry was stirred for five minutes. Then, MgO and MnCl₂·4H₂O were added to the ligand solution and stirred for an additional 5 min. The resulting molarity for the various components in the solution was ˜0.51 M H₄DOBPDC, ˜1.11 M MgO, and ˜0.058 M MnCl₂. The metal and ligand solution was transferred to a Teflon-lined autoclave, sealed, and placed in a 120° C. oven for 16 h under static conditions.

### Example 7—Synthesis of EMM-67 in Water with MgO and MnO

In order to prepare EMM-67, H₄DOBPDC ligand was added to a vessel with distilled water. The ligand slurry was stirred for five minutes. Then, MgO and MnO were added to the ligand solution and stirred for an additional 5 min. The resulting molarity for the various components in the solution was ˜0.51 M H₄DOBPDC, ˜1.11 M MgO, and ˜0.054 M MnO. The metal and ligand solution was transferred to an Teflon-lined autoclave, sealed, and placed in a 120° C. oven for 16 h under static conditions.

### Example 8—Additional Synthesis Procedure Example

The following provides another example of a synthesis procedure that could be used for formation of MOF structures. According to this procedure, a Mg/Mn solution can be prepared in water prior to synthesis (Mn/Mg molar ratio range: 0.0001-0.5). Ligand can then be added in appropriate amounts (Ligand:Metal ranging between 0.25-0.55). Water can then be added to the ligand in order to disperse the solids (with a metal+ligand concentration ranging between 0.2-3.5 mmol/mL). Subsequently, NaOH solution can then be added to the ligand and water in order to deprotonate the ligand (Na:Ligand range: 2-6). Appropriate amounts of Mg/Mn solution can then be added to autoclaves containing the ligand, water, and NaOH. The reactants can then be heated to appropriate temperatures (Temperature ranges: 20-180° C.) over appropriate time periods (1-120 hrs). Final products can then be washed with methanol.

### ADDITIONAL EMBODIMENTS

Embodiment 1. A method of making a metal organic framework composition, comprising: dissolving a plurality of solid reagents in a solvent comprising 40 vol % or more of water, to provide a synthesis solution, the plurality of solid reagents comprising at least one metal salt and at least one multi-ring disalicylate linker, the at least one metal salt comprising an oxide, a hydroxide, a carbonate, an acetate, or a combination thereof, the synthesis solution consisting essentially of the solvent, the at least one metal salt, and the at least one multi-ring disalicylate linker; and heating the synthesis solution to form a composition comprising a metal organic framework, wherein the metal organic framework comprises the metal of the at least one metal salt and the multi-ring disalicylate organic linker.

Embodiment 2. A method of making a metal organic framework composition, comprising: dissolving a plurality of solid reagents in a solvent comprising 40 vol % or more of water, to provide a synthesis solution, the plurality of solid reagents comprising at least one metal salt and at least one multi-ring disalicylate linker, the at least one metal salt comprising an oxide, a hydroxide, a carbonate, an acetate, or a combination thereof; and heating the synthesis solution to form a composition comprising a metal organic framework, wherein the metal organic framework comprises the metal of the at least one metal salt and the multi-ring disalicylate organic linker, and wherein a pH of the synthesis solution is substantially the same as the pH of a mixture consisting of the solvent, the at least one metal salt, and the at least one multi-ring disalicylate linker in the same molar ratio as the synthesis solution

Embodiment 3. The method of any of the above embodiments, wherein a plurality of rings in the multi-ring disalicylate organic linker comprise a salicylate functional group; or wherein a plurality of rings in the multi-ring disalicylate organic linker are connected by at least one of a biphenyl linkage, a vinyl linkage, and an alkyl linkage; or wherein the linker is H₄DOBDPC; or a combination thereof.

Embodiment 4. The method of any of the above embodiments, wherein the metal organic framework is of the formula: M¹₂(A) where M¹ comprises a metal cation, and A comprises a multi-ring disalicylate organic linker, or wherein the metal organic framework is of the formula: M¹ₓM₍₂₋ₓ₎(A) where M¹ and M² comprise metal cations, x ranges from 0 to 2, and A comprises a multi-ring disalicylate organic linker.

Embodiment 5. The method of Embodiment 4, wherein M¹ and M² comprise different metallic elements, or wherein A comprises a plurality of multi-ring disalicylate organic linkers, or wherein at least one of M¹ and M² comprises a divalent metal ion, or a combination thereof.

Embodiment 6. The method of any of the above embodiments, wherein the at least one metal salt comprises an oxide, a hydroxide, or a combination thereof.

Embodiment 7. The method of any of the above embodiments, wherein the solvent comprises 99 vol % or more of water; or wherein the solvent comprises 40 vol % to 99 vol % of water and 1.0 vol % to 60 vol % of one or more alcohols, the one or more alcohols optionally comprising ethanol, isopropyl alcohol, or a combination thereof.

Embodiment 8. The method of any of the above embodiments, wherein the synthesis solution comprises a molar ratio of the at least one linker to metal from the at least one metal salt of 0.20 to 0.60; or wherein the synthesis solution comprises a concentration of the at least one metal salt of 0.1 M to 4.85 M; or wherein the synthesis solution comprises a concentration of the at least one linker of 0.03 M to 1.95 M; or a combination thereof.

Embodiment 9. The method of any of the above embodiments, wherein the metal organic framework comprises, as determined by nitrogen adsorption, a) a surface area of 700 m²/g or more, b) a micropore volume of 0.6 cm³/g to 1.6 cm³/g, or c) a combination of a) and b).

Embodiment 10. The method of any of the above embodiments, wherein the plurality of solid reagents comprise a plurality of metal salts, the plurality of metal salts comprising at least one magnesium salt and at least one manganese salt.

Embodiment 11. The method of any of the above embodiments, wherein the metal organic framework comprises MOF-274, EMM-67, or a combination thereof.

Embodiment 12. The method of any of the above embodiments, wherein the synthesis solution is heated to between 100° C. and 160° C.

Embodiment 13. The method of any of the above embodiments, wherein the metal organic framework is of the formula: M¹ₓM²₍₂₋ₓ₎(A) where M¹ and M² are metal cations, x ranges from 0 to 2, and A is I) a disalicylate organic linker, or II) a plurality of linkers selected independently from a group consisting of:

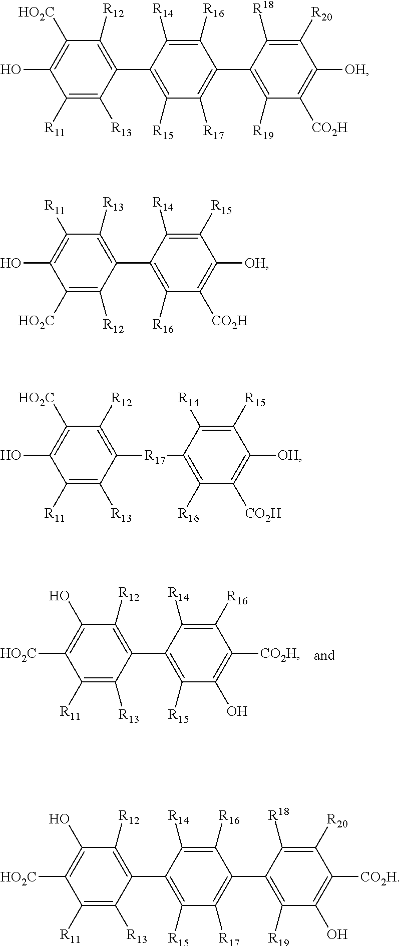

wherein R₁₁, R₁₂, R₁₃, R₁₄, R₁₅, R₁₆, R₁₇, R₁₈, R₁₉, and R₂₀ are each independently selected from H, halogen, hydroxyl, methyl, and halogen substituted methyl; and R₁₇ is selected from the group consisting of substituted or unsubstituted aryl, vinyl, alkynyl, substituted or unsubstituted heteroaryl, divinyl benzene, and diacetyl benzene.

Embodiment 14. The method of any of the above embodiments, wherein the mixed metal organic framework provides an X-ray diffraction pattern that can be indexed to a hexagonal unit cell, where the unit cell is selected from space groups 168 to 194; or wherein the metal organic framework produces powder x-ray diffraction peaks at 2θ values between about 4° and about 6° and between about 7° and about 9°; or a combination thereof.

Additional Embodiment A. A metal organic framework composition made according to the method of any of Embodiments 1 to 14.

Certain features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values take into account experimental error and variations that would be expected by a person having ordinary skill in the art.

The foregoing description of the disclosure illustrates and describes the present methodologies. Additionally, the disclosure shows and describes exemplary methods, but it is to be understood that various other combinations, modifications, and environments may be employed and the present methods are capable of changes or modifications within the scope of the concept as expressed herein, commensurate with the above teachings and/or the skill or knowledge of the relevant art.

We claim:

1. A method of making a metal organic framework composition, comprising:
dissolving a plurality of solid reagents in a solvent comprising 40 vol % or more of water, to provide a synthesis solution, the plurality of solid reagents comprising at least one metal salt and at least one multi-ring disalicylate linker, the at least one metal salt comprising an oxide, a hydroxide, a carbonate, an acetate, or a combination thereof, the synthesis solution consisting essentially of the solvent, the at least one metal salt, and the at least one multi-ring disalicylate linker; and
heating the synthesis solution to form a composition comprising a metal organic framework,
wherein the metal organic framework comprises the metal of the at least one metal salt and the multi-ring disalicylate organic linker.

2. The method of claim 1, wherein a plurality of rings in the multi-ring disalicylate organic linker comprise a salicylate functional group; or wherein a plurality of rings in the multi-ring disalicylate organic linker are connected by at least one of a biphenyl linkage, a vinyl linkage, and an alkyl linkage; or wherein the linker is H₄DOBDPC; or a combination thereof.

3. The method of claim 1, wherein the metal organic framework is of the formula: M¹₂(A) where M¹ comprises a metal cation, and A comprises a multi-ring disalicylate organic linker, or
wherein the metal organic framework is of the formula: M¹ₓM²₍₂₋ₓ₎(A) where M¹ and M² comprise metal cations, x ranges from 0 to 2, and A comprises a multi-ring disalicylate organic linker.

4. The method of claim 3, wherein M¹ and M² comprise different metallic elements, or wherein A comprises a plurality of multi-ring disalicylate organic linkers, or wherein at least one of M¹ and M² comprises a divalent metal ion, or a combination thereof.

5. The method of claim 1, wherein the at least one metal salt comprises an oxide, a hydroxide, or a combination thereof.

6. The method of claim 1, wherein the solvent comprises an alcohol, an ether, or a combination thereof.

7. The method of claim 1, wherein the solvent comprises 99 vol % or more of water.

8. The method of claim 1, wherein the synthesis solution comprises a molar ratio of the at least one linker to metal from the at least one metal salt of 0.20 to 0.60.

9. The method of claim 1, wherein the synthesis solution comprises a concentration of the at least one metal salt of 0.1 M to 4.85 M; or wherein the synthesis solution comprises a concentration of the at least one linker of 0.03 M to 1.95 M; or a combination thereof.

10. The method of claim 1, wherein the metal organic framework comprises, as determined by nitrogen adsorption, a) a surface area of 700 m²/g or more, b) a micropore volume of 0.6 cm³/g to 1.6 cm³/g, or c) a combination of a) and b).

11. The method of claim 1, wherein the solvent comprises 40 vol % to 99 vol % of water and 1.0 vol % to 60 vol % of one or more alcohols.

12. The method of claim 11, wherein the one or more alcohols comprise ethanol, isopropyl alcohol, or a combination thereof.

13. The method of claim 1, wherein the plurality of solid reagents comprise a plurality of metal salts, the plurality of metal salts comprising at least one magnesium salt and at least one manganese salt.

14. The method of claim 1, wherein the metal organic framework comprises MOF-274, EMM-67, or a combination thereof.

15. The method of claim 1, wherein the synthesis solution is heated to between 100° C. and 160° C.

16. The method of claim 1, wherein the method further comprises:
filtering the synthesis solution to after the heating to recover the composition;
washing the composition with water and filtering to recover the water-washed composition; and
performing a plurality of washes of the water-washed composition with alcohol and filtering to recover the alcohol-washed composition.

17. The method of claim 1, wherein the linker comprises a plurality of linkers selected independently from a group consisting of: 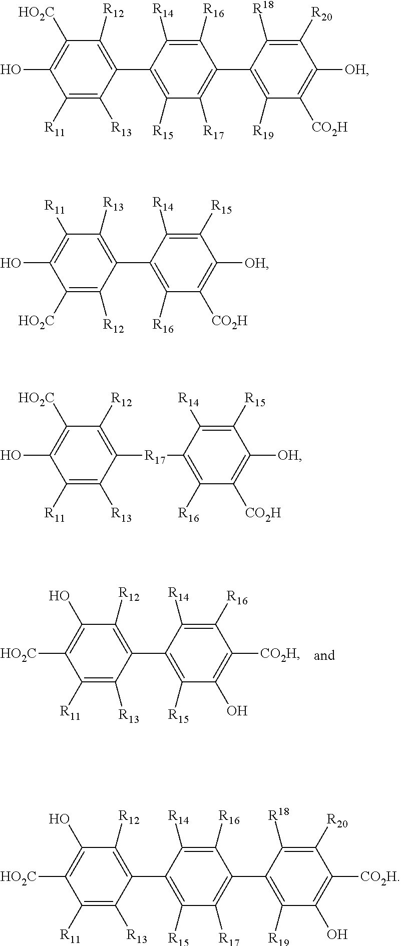
wherein R₁₁, R₁₂, R₁₃, R₁₄, R₁₅, R₁₆, R₁₇, R₁₈, R₁₉, and R₂₀ are each independently selected from H, halogen, hydroxyl, methyl, and halogen substituted methyl; and
R₁₇ is selected from the group consisting of substituted or unsubstituted aryl, vinyl, alkynyl, substituted or unsubstituted heteroaryl, divinyl benzene, and diacetyl benzene.

18. The method of claim 1, wherein the mixed metal organic framework provides an X-ray diffraction pattern that can be indexed to a hexagonal unit cell, where the unit cell is selected from space groups 168 to 194; or wherein the metal organic framework produces powder x-ray diffraction peaks at 2θ values between about 4° and about 6° and between about 7° and about 9°; or a combination thereof.

19. A method of making a metal organic framework composition, comprising:
dissolving a plurality of solid reagents in a solvent comprising 40 vol % or more of water, to provide a synthesis solution, the plurality of solid reagents comprising at least one metal salt and at least one multi-ring disalicylate linker, the at least one metal salt comprising an oxide, a hydroxide, a carbonate, an acetate, or a combination thereof; and
heating the synthesis solution to form a composition comprising a metal organic framework,
wherein the metal organic framework comprises the metal of the at least one metal salt and the multi-ring disalicylate organic linker, and
wherein a pH of the synthesis solution is substantially the same as the pH of a mixture consisting of the solvent, the at least one metal salt, and the at least one multi-ring disalicylate linker in the same molar ratio as the synthesis solution.
